(19) United States
(12) Patent Application Publication
(10) Pub. No.: US 2026/0011002 A1
(43) Pub. Date: Jan. 8, 2026

(54) METHOD OF, AND APPARATUS FOR, ESTIMATION OF PARAMETERS INDICATIVE OF RISK OF SPONTANEOUS PRE-TERM BIRTH

(71) Applicant: Prenaital ApS, Dragør (DK)

(72) Inventors: Paraskevas PEGIOS, Copenhagen (DK); Emilie Pi Fogtmann SEJER, Copenhagen (DK); Manxi LIN, Lyngby (DK); Zahra BASHIR, Taastrup (DK); Morten Bo Søndergaard SVENDSEN, Humlebæk (DK); Mads NIELSEN, Dragør (DK); Eike PETERSEN, Hildesheim (DE); Anders Nymark CHRISTENSEN, Allerød (DK); Martin TOLSGAARD, Copenhagen (DK); Aasa FERAGEN, Copenhagen (DK)

(21) Appl. No.: 18/763,236

(22) Filed: Jul. 3, 2024

(51) Int. Cl. G06T 7/00; G06T 7/11; G06V 10/26; G06V 10/75; G06V 10/82

(52) U.S. Cl. CPC G06T 7/0012; G06T 7/11; G06V 10/26; G06V 10/758; G06V 10/82; G06T 2207/10132; G06T 2207/20084; G06T 2207/20112

(57) ABSTRACT

There is provided a computer system and a computer-implemented method for prediction of parameters indicative of the risk of spontaneous preterm birth (sPTB) for a subject under assessment, the method being executed by at least one hardware processor and comprising the steps of: providing one or more ultrasound images comprising medical image data representative of the anatomical structure and appearance of at least a part of a cervix of the subject; providing a plurality of segmentations of the medical image data each representative of one or more features of the anatomical structure and appearance of the at least a part of the cervix of the subject; and utilizing i) the medical image data, ii) spatial information associated with the medical image data and iii) one or more of the segmentations in a classifier model to determine a prediction metric indicative of the likelihood of sPTB for the subject.

### ACKNOWLEDGMENT

Pegios, P., Sejer, E. P. F., Lin, M., Bashir, Z., Svendsen, M. B. S., Nielsen, M., Petersen, E., Christensen, A. N., Tolsgaard, M., & Feragen, A. (2023) “Leveraging Shape and Spatial Information for Spontaneous Preterm Birth Prediction”, Simplifying Medical Ultrasound—4th International Workshop, ASMUS 2023, Held in Conjunction with MICCAI 2023, Proceedings (pp. 57-67), of which all of the above authors are also named inventors of the present application, is incorporated herein by reference.

### BACKGROUND OF THE INVENTION

The present invention relates to a method of, and apparatus for, improved estimation of parameters indicative of risk of spontaneous pre-term birth. More particularly, the present invention relates to a method for predicting potential preterm birth from medical scan data, which may be used in practice by medical professionals for risk analysis and prognosis of potential pathologies.

Spontaneous preterm birth (sPTB), usually defined as birth occurring before 37 weeks of gestation, is considered a pressing challenge, with substantial health, societal, and financial implications. Affecting millions of cases annually it is the key factor causing neonatal morbidity, as premature infants are vulnerable to several complications. These risks often necessitate prolonged hospitalization in neonatal intensive care units, with potentially adverse outcomes.

The ability to accurately predict sPTB is of paramount importance in the prevention of neonatal mortality and morbidity. By identifying pregnancies at risk, healthcare professionals can provide support to the affected infants and their families.

The conventional approach to Cervical length (CL) measurements obtained from cervical ultrasound images currently serve as the clinical gold standard for sPTB prediction, with a threshold usually of CL<25 mm indicating an increased risk.

However, there is significant variability in operator performance which can be affected by multiple factors including image quality and human error when measuring the cervical parameters. To minimize the operator variance when estimating CL, automated methods have been proposed.

However, attempts to automate such measurements have met with limited success. Existing methods can suffer from potential risk of bias due to their small effective sample size and a lack of transparency with regard to model form and calibration evaluation for assessing the reliability of individual confidences.

The present invention aims, in embodiments, to address these issues.

### SUMMARY OF THE INVENTION

The following introduces a selection of concepts in a simplified form in order to provide a foundational understanding of some aspects of the present disclosure. The following is not an extensive overview of the disclosure and is not intended to identify key or critical elements of the disclosure or to delineate the scope of the disclosure. The following merely summarizes some of the concepts of the disclosure as a prelude to the more detailed description provided thereafter.

Several preferred aspects of the methods and systems according to the present invention are outlined below.

According to a first aspect of the present invention, there is provided a computer-implemented method for prediction of parameters indicative of the risk of spontaneous preterm birth (sPTB) for a subject under assessment, the method being executed by at least one hardware processor and comprising the steps of: a) providing one or more ultrasound images comprising medical image data representative of the anatomical structure and appearance of at least a part of a cervix of the subject; b) providing a plurality of segmentations of the medical image data each representative of one or more features of the anatomical structure and appearance of the at least a part of the cervix of the subject; and c) utilizing i) the medical image data, ii) spatial information associated with the medical image data and iii) one or more of the segmentations in a classifier model to determine a prediction metric indicative of the likelihood of sPTB for the subject.

In one embodiment, step b) comprises: d) utilizing the medical image data in a segmentation model configured to perform segmentation of the medical image data to generate the plurality of segmentations each representative of features of the anatomical structure and appearance of the at least a part of the cervix of the subject.

In one embodiment, the segmentation model comprises a machine learning model.

In one embodiment, the segmentation model comprises one or more neural networks.

In one embodiment, the segmentation model comprises one or more U-net convolutional neural networks.

In one embodiment, the method further comprises: e) automatically determining a qualitative value for one or more clinical cervical parameters based on the plurality of segmentations.

In one embodiment, the one or more clinical cervical parameters comprise cervical length (CL) and/or utero-cervical angle (UCA).

In one embodiment, the classifier model comprises one or more machine learning classifiers.

In one embodiment, the classifier model comprises one or more neural network classifiers.

In one embodiment, the spatial information comprises pixel spacing information representing the physical distance between the respective centers of each pixel.

In one embodiment, the spatial information comprises pixel statistical information.

In one embodiment, the pixel statistical information comprises the variance and/or entropy of at least a part of the medical image data.

In one embodiment, the pixel statistical information relates to a part of the medical image data derived from one or more segmented regions of one or more segmentations.

In one embodiment, prior to step c), the medical input data is pre-processed to remove embedded text and/or markings from the one or more ultrasound images.

In one embodiment, the prediction metric comprises a probabilistic risk score.

In one embodiment, the method further comprises: f) generating an uncertainty estimate for the prediction metric.

In one embodiment, step f) further comprises: g) applying one or more transforms to the one or more ultrasound images to generate a set of augmented images; h) performing steps b) and c) using the set of augmented images to determine a prediction metric based on the set of augmented images.

In one embodiment, the steps g) and h) are repeated N times to generate N values of the prediction metric.

In one embodiment, the one or more transforms are randomly selected from one or more of: rotation; shear; translation; brightness; contrast; and horizontal flip.

In one embodiment, step a) comprises: generating one or more trans-vaginal ultrasound images of the at least a part of the cervix using an ultrasound imaging apparatus.

According to a second aspect of the present invention, there is provided a computational model for prediction of parameters indicative of the risk of spontaneous preterm birth (sPTB) for a subject under assessment, the computational model comprising: a classification model comprising one or more classifiers configured to process i) medical image data from one or more ultrasound images, the medical image data being representative of the anatomical structure and appearance of at least a part of a cervix of a subject, ii) spatial information associated with the medical image data and iii) a plurality of segmentations of the medical image data each representative of one or more features of the anatomical structure and appearance of the at least a part of the cervix of the subject to determine a prediction metric indicative of the likelihood of sPTB for the subject.

In one embodiment, further comprising a segmentation model configured to perform segmentation of the medical image data to generate the plurality of segmentations each representative of features of the anatomical structure and appearance of the at least a part of the cervix of the subject.

In one embodiment, the segmentation model is further configured to determine a qualitative value for one or more clinical cervical parameters based on the plurality of segmentations.

In one embodiment, the classification model comprises a machine learning model.

In one embodiment, the classification model comprises one or more neural networks.

In one embodiment, the segmentation model comprises a machine learning model.

In one embodiment, the segmentation model comprises one or more U-net convolutional neural networks.

In one embodiment, the segmentation model is further configured to automatically determine a qualitative value for one or more clinical cervical parameters based on the plurality of segmentations.

In one embodiment, the one or more clinical cervical parameters comprise cervical length (CL) and/or utero-cervical angle (UCA).

In one embodiment, the spatial information comprises pixel spacing information representing the physical distance between the respective centers of each pixel.

In one embodiment, the spatial information comprises pixel statistical information.

In one embodiment, the pixel statistical information comprises the variance and/or entropy of at least a part of the medical image data.

In one embodiment, the pixel statistical information relates to a part of the medical image data derived from one or more segmented regions of one or more segmentations.

In one embodiment, the prediction metric comprises a probabilistic risk score.

According to a third aspect of the present invention, there is provided a computing system for prediction of parameters indicative of the risk of spontaneous preterm birth (sPTB) for a subject under assessment, the computing system comprising: at least one hardware processor; and an analyzer, the analyzer comprising: a classification model comprising one or more classifiers configured to process i) medical image data from one or more ultrasound images, the medical image data being representative of the anatomical structure and appearance of at least a part of a cervix of a subject, ii) spatial information associated with the medical image data and iii) a plurality of segmentations of the medical image data each representative of one or more features of the anatomical structure and appearance of the at least a part of the cervix of the subject to determine a prediction metric indicative of the likelihood of sPTB for the subject.

In one embodiment, the analyzer further comprises a segmentation model configured to perform segmentation of the medical image data to generate the plurality of segmentations each representative of features of the anatomical structure and appearance of the at least a part of the cervix of the subject.

In one embodiment, the segmentation model is further configured to determine a qualitative value for one or more clinical cervical parameters based on the plurality of segmentations.

In one embodiment, the classification model comprises a machine learning model.

In one embodiment, the classification model comprises one or more neural networks.

In one embodiment, the segmentation model comprises a machine learning model.

In one embodiment, the segmentation model comprises one or more U-net convolutional neural networks.

In one embodiment, the segmentation model is further configured to automatically determine a qualitative value for one or more clinical cervical parameters based on the plurality of segmentations.

In one embodiment, the one or more clinical cervical parameters comprise cervical length (CL) and/or utero-cervical angle (UCA).

In one embodiment, the spatial information comprises pixel spacing information representing the physical distance between the respective centers of each pixel.

In one embodiment, the spatial information comprises pixel statistical information.

In one embodiment, the pixel statistical information comprises the variance and/or entropy of at least a part of the medical image data.

In one embodiment, the pixel statistical information relates to a part of the medical image data derived from one or more segmented regions of one or more segmentations.

In one embodiment, the prediction metric comprises a probabilistic risk score.

According to a fourth aspect of the present invention, there is provided an ultrasound imaging apparatus comprising an ultrasound scanner configured to generate a plurality of trans-vaginal ultrasound images of at least a part of the cervix of a subject under assessment and the computing system according to the third aspect.

According to a fifth aspect of the present invention, there is provided a non-transitory computer readable storage medium storing a program of instructions executable by at least one hardware processor to perform the steps of: providing one or more ultrasound images comprising medical image data representative of the anatomical structure and appearance of at least a part of a cervix of the subject; providing a plurality of segmentations of the medical image data each representative of one or more features of the anatomical structure and appearance of the at least a part of the cervix of the subject; and utilizing i) the medical image data, ii) spatial information associated with the medical image data and iii) one or more of the segmentations in a classifier model to determine a prediction metric indicative of the likelihood of sPTB for the subject.

According to a sixth aspect of the present invention there is provided a method of performing ultrasound examination of a subject under assessment to predict parameters indicative of the risk of spontaneous preterm birth (sPTB), the method comprising the steps of: acquiring a plurality of trans-vaginal ultrasound images of at least a part of a cervix of the subject using an ultrasound imaging apparatus, the one or more ultrasound images comprising medical image data representative of the anatomical structure and appearance of at least a part of the cervix; utilizing, on a computing system, the ultrasound images in a computational model to determine qualitative values for one or more clinical cervical parameters and/or a prediction metric indicative of the likelihood of sPTB for the subject; utilizing, on the computing system, the computational model to generate an associated uncertainty estimate for the qualitative values for the one or more clinical cervical parameters and/or the prediction metric indicative of the likelihood of sPTB for the subject; and providing, based on the uncertainty estimate, a notification to the operator of the ultrasound imaging apparatus in respect of one or more parameters indicative of the accuracy of one or more of the obtained ultrasound images.

In one embodiment, step b) further comprises determining qualitative values for one or more clinical cervical parameters by: e) providing a plurality of segmentations of the medical image data each representative of one or more features of the anatomical structure and appearance of the at least a part of the cervix of the subject; and f) automatically determining a qualitative value for one or more clinical cervical parameters based on the plurality of segmentations.

In one embodiment, step e) further comprises: g) utilizing the medical image data in a segmentation model of the computational model configured to perform segmentation of the medical image data to generate the plurality of segmentations each representative of features of the anatomical structure and appearance of the at least a part of the cervix of the subject.

In one embodiment, step b) further comprises determining a prediction metric indicative of the likelihood of sPTB for the subject by: h) utilizing i) the medical image data, ii) spatial information associated with the medical image data and iii) one or more of the segmentations in a classifier model of the computational model to determine a prediction metric indicative of the likelihood of sPTB for the subject.

According to a seventh aspect of the present invention, there is provided an ultrasound imaging apparatus comprising: an ultrasound scanner configured to obtain a plurality of trans-vaginal ultrasound images of at least a part of the cervix of a subject under assessment, the one or more ultrasound images comprising medical image data representative of the anatomical structure and appearance of at least a part of the cervix; a computing system comprising at least one hardware processor and configured to: utilize the ultrasound images in a computational model to determine qualitative values for one or more clinical cervical parameters and/or a prediction metric indicative of the likelihood of sPTB for the subject; utilize the computational model to generate an associated uncertainty estimate for the qualitative values for the one or more clinical cervical parameters and/or the prediction metric indicative of the likelihood of sPTB for the subject; and provide, based on the uncertainty estimate, a notification to the operator of the ultrasound in respect of one or more parameters indicative of the accuracy of one or more of the obtained ultrasound images.

In one embodiment, the computational model is further configured to determine qualitative values for one or more clinical cervical parameters by: providing a plurality of segmentations of the medical image data each representative of one or more features of the anatomical structure and appearance of the at least a part of the cervix of the subject; and automatically determining a qualitative value for one or more clinical cervical parameters based on the plurality of segmentations.

In one embodiment, the computational model is further configured to utilize the medical image data in a segmentation model of the computational model configured to perform segmentation of the medical image data to generate the plurality of segmentations each representative of features of the anatomical structure and appearance of the at least a part of the cervix of the subject.

### BRIEF DESCRIPTION OF DRAWINGS

Embodiments of the present invention will now be described in detail with reference to the accompanying drawings, in which:

FIG. 1 shows a schematic diagram of a medical analysis computing system according to an embodiment;

FIG. 2 shows a schematic diagram of an ensemble model for use with the medical analysis computing system of FIG. 1 according to an embodiment;

FIG. 3 shows a detailed schematic diagram of an ensemble model for use with the medical analysis computing system of FIG. 1 according to an embodiment;

FIGS. 4A-4E show an example of data from a term birth (top row) and a preterm birth (bottom row). FIG. 4A shows the original image data 106 in each case. FIG. 4B shows the CL measurements (expert annotated are shown as a solid dark grey line and the predicted measurements as a dashed white line). FIG. 4C shows expert segmentations and FIG. 4D shows predicted segmentations (corresponding to the segmentation predictions 110 of embodiments. Finally, FIG. 4E shows a binary mask;

FIG. 5 shows a schematic diagram of the components of the first model;

FIG. 6 shows the segmentation performance of an embodiment of the model 100 in detecting the four cervical structures, CC, OB, IB, and BL (K=5, including background);

FIG. 7 shows receiver operating characteristic (ROC) curves (left hand figure), loess-based reliability diagrams (centre) and distribution of model predictions (right hand figure) for a plurality of models under test;

FIG. 8 shows confusion matrices for CL-based predictions in FIG. 8a and embodiments of the model 100 in FIG. 8b. (Dis)-agreement matrices between the two approaches for term and preterm births are shown in FIGS. 8c and 8d, respectively;

FIG. 9 shows non-limiting examples of high-confidence preterm birth correct predictions for a short, CL=19.8 mm, (top row) and a larger, CL=30.1 mm, (bottom row) cervix. FIG. 9A shows the respective image 106 without cofounders, FIG. 9B shows the first model's segmentation predictions 100, and FIG. 9C shows the automatic CL measurements 108. Saliency maps on top of the input image are shown in FIG. 9D;

FIG. 10 shows a flow chart of a first embodiment of the method of the present invention;

FIG. 11 shows a flow chart of a second embodiment of the method of the present invention;

FIG. 12 shows a flow chart of a third embodiment of the method of the present invention;

Embodiments of the present disclosure and their advantages are best understood by referring to the detailed description that follows. It should be appreciated that like reference numbers are used to identify like elements illustrated in one or more of the figures, wherein showings therein are for purposes of illustrating embodiments of the present disclosure and not for purposes of limiting the same.

### DETAILED DESCRIPTION OF THE INVENTION

Various examples and embodiments of the present disclosure will now be described. The following description provides specific details for a thorough understanding and enabling description of these examples. One of ordinary skill in the relevant art will understand, however, that one or more embodiments described herein may be practiced without many of these details.

Likewise, one skilled in the relevant art will also understand that one or more embodiments of the present disclosure can include other features and/or functions not described in detail herein. Additionally, some well-known structures or functions may not be shown or described in detail below, so as to avoid unnecessarily obscuring the relevant description.

It is noted herein that the term “subject” and “subject under assessment” is intended to relate to a human female subject.

The present invention is directed to the technical field of medical imaging and analysis using machine learning. The technology described herein provides technical improvements to the existing known art. The inventors of the present application have recognised, for the first time, that the shape, size, and texture of the cervix in ultrasound images can be predictive of sPTB.

In addition, the inventors have recognised, for the first time, that the inherent texture bias of convolutional neural networks (CNNs) present potential barriers to accurate prediction of sPTB. Therefore, in embodiments, shape and spatial information is injected to a predictive classifier model. This has been found to enable a sufficiently accurate model such that a probabilistic risk score generated by the model is shown to be well-calibrated as a probability of a subject under assessment having a risk of sPTB.

Accordingly, the systems and methods described herein, utilizing shape and spatial information provides an improvement to the functioning of computers by improving the functioning of CNNs in the prediction of sPTB. Baumgartner, C. F., et al. “SonoNet: real-time detection and localisation of fetal standard scan planes in freehand ultrasound”, IEEE TMI 36(11) (2017), incorporated by reference herein, describes methods that involve a machine learning model to predict sonography features in standard plane images.

This reference is directed to fetal standard plane imaging. The present invention is directed to a different technical problem, namely accurate prediction of sPTB. In addition, the models described in the above disclosure have been improved upon through the use of shape and spatial information to enable improved calibration, accuracy and robustness to enable a well-founded correlation between model predictions and the likelihood of risk of sPTB.

The present invention relates to a medical analysis system and method operable to provide an estimate of cervical parameters from ultrasound images. In embodiments, the medical analysis system and method are operable to provide an uncertainty estimate for one or more cervical parameters.

The medical analysis system comprises one or more machine learning algorithms to identify parameters of interest in scan data. The parameters are identified by means of a training process which enables classification and utilization of specific features within images by means of one or more quantitative indicators or parameters indicative of cervical parameters.

This is a significant improvement on known arrangements which require analysis of scan data to be performed by a medical professional or sonographer either during or after the scan session has been completed.

### Medical Imaging System Configuration

The present invention relates to a medical analysis computing system 10. The computing system 10 may take any suitable form and may comprise, for example, a cloud-based computing system, a remote computer connected over a network, a local workstation or a dedicated medical imaging console.

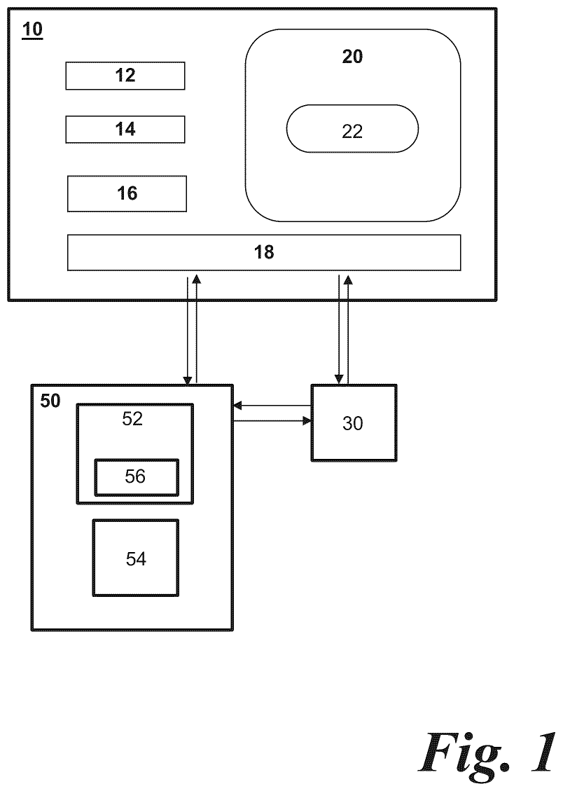

FIG. 1 shows a computing system 10 according to an embodiment. The computing system 10 comprises one or more physical processors 12, a computer-readable physical memory 14 and a non-transitory storage device 16 such as, for example, a hard disk drive or solid-state drive.

The one or more physical hardware processors 12 may comprise any suitable processor types; for example, central processing units (CPUs), graphical processing units (GPUs) or any other suitable processor such as, for example, Field Programmable Gate Arrays (FPGAs) and stream processors.

The storage device 16 may take any suitable form and may include storage device(s) local to the computing system 10 and/or storage devices external to the computing system 10. For example, the storage device 16 may comprise cloud or other virtual networked storage.

The computing system 10 further comprises an interface 18 through which image data is received. The interface 18 may take any suitable form and may be in the form of a communications interface and/or a network connection to a suitable source of input medical image data.

A computing application 20 is run on the computing system and is executable to cause the computing system 10 to perform the method of the present invention. The computing application 20 comprises an analyzer 22.

The computing application 20 utilizes one or more machine learning algorithms to analyze and process medical image data. In embodiments, in use, the computing application 20 comprises two aspects-a training stage and an operational stage.

In non-limiting embodiments, the computing application 20 is operable to communicate through the interface 18 with a picture archiving and communication system (PACS) 30. The PACS 30 comprise an industry-standard device and format for medical imaging.

This is, however, not intended to be limiting and other configurations may be used. The PACS 30 may be operable to process data in Digital Imaging and Communications in Medicine (DICOM) format. However, again this is non limiting and the skilled person would readily be aware of other formats which could be used.

Further, in non-limiting embodiments, the computing application 20 is operable to communicate through the interface 18 with a medical imaging device 50 in the form of an ultrasound imaging apparatus 50.

The ultrasound imaging apparatus 50 comprises an ultrasound scanner 52 and a reading station 54. The reading station 54 may be local to the ultrasound scanner 52 (e.g. a computer and monitor system) or may be located remotely therefrom. The reading station 54 can be used by a medical practitioner and/or sonographer to read, interpret and analyze image data and biometric data generated therefrom.

In embodiments, the ultrasound imaging apparatus 50 is connected to the PACS 30 to access and store data relating to a subject under assessment (i.e. a pregnant woman under assessment). This may, in embodiments, comprise image data. However, this is not intended to be limiting and other biometric- or health-related information relating to the subject under assessment may be utilized. This may include data such as health conditions, date of conception, last menstrual period, or other data.

The ultrasound scanner 52 of the ultrasound imaging apparatus 50 is operable to perform trans-vaginal ultrasound imaging to image the cervix of the subject under assessment. The ultrasound scanner 52 comprises a probe 56 to transmit the ultrasound signals and to recover reflected ultrasound signals in order to obtain measurement data to enable imaging of the cervix of the subject under assessment.

The probe 56 may comprise a probe cover to protect the ultrasonic elements of the probe 56 and to enable the probe 56 to be inserted into the vagina in a comfortable manner and placed in the distal vagina or against the external cervical os.

In use, sagittal imaging may be obtained through the radiographer making side-to-side movements of the probe 56, and a transverse/semi-coronal orientation may be obtained through rotation of the probe by 90 degrees. The cervix, endocervical canal and internal os may be imaged in both transverse (short-axis) and sagittal (long-axis) orientations if required.

In embodiments, the measured signals obtained through the scanning operation may comprise B-mode signals which are used to generate B-scan (2D brightness scan) ultrasound images of the cervix from a number of predetermined orientations.

In embodiments, the computing system 10 may be separate from the ultrasound imaging apparatus 50 and receive data from the ultrasound imaging apparatus 50 via PACS 30.

Alternatively, whilst shown schematically and separately therefrom, the computing system 10 may be integrated into the ultrasound imaging apparatus 50 and may form a part thereof. For example, the computing application 20 may be run on the computing system 10 forming part of the ultrasound imaging apparatus 50 and provide data to the user (i.e. medical practitioner and/or sonographer) using the ultrasound imaging apparatus 50 to enable them to read, interpret and analyze image data and biometric data generated therefrom.

In such embodiments, the computing application 20 may comprise a computing module executed on the computing apparatus 10 of the ultrasound imaging apparatus 50.

Alternatively, the computing application 20 may utilize medical image data obtained from other sources and may be run on a computing system 10 such as a post-processing workstation or cloud solution working on medical scan image data.

### Model Architecture

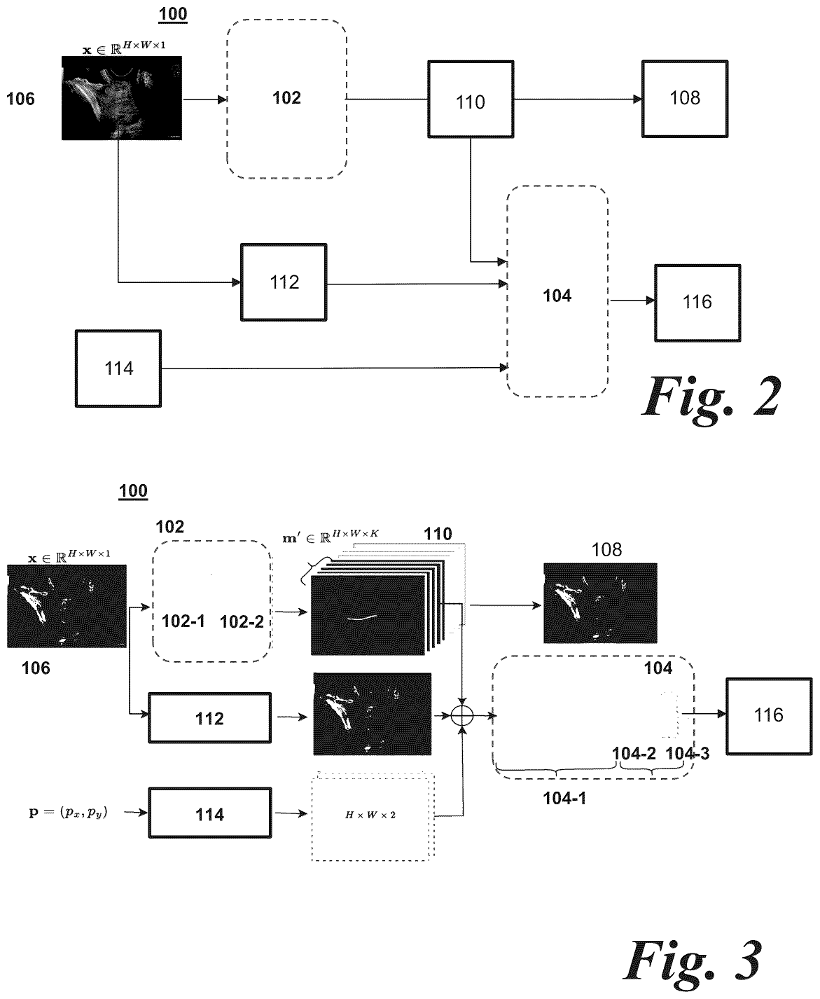

The computing application 20 will now be described with reference to FIGS. 2 and 3. In embodiments, the analyzer 22 comprises one or more computational models. FIG. 2 shows a general schematic overview of a model 100 and the inputs, outputs and components thereof. FIG. 3 shows a detailed schematic diagram of a specific embodiment of the model 100 and machine learning algorithms.

In embodiments, the analyzer 22 comprise a computational model 100 which is operable to estimate a value of one or more parameters indicative of risk of spontaneous pre-term birth (sPTB).

FIG. 2 shows a schematic of the configuration of the model 100. The computational model 100 comprises first and second models 102, 104. The first and second models 102, 104 may each comprise one or more models. For example, each of the first and second models 102, 104 may themselves comprise ensemble models.

The first model 102 comprises one or more algorithms operable to utilize one or more medical images 106 as inputs to determine and quantify one or more measurements 108 of the input anatomical structure which is the subject of the input medical images 106.

The first model 102 comprises a classifier in the form of a segmentation model operable to segment the input medical images 106 to generate one or more segmentation predictions 108. The first model 102 may take any suitable form operable to classify image features and appearance in order to generate appropriate segmentation predictions 108.

For example, in embodiments, the first model 102 may perform segmentation operations using image processing techniques and mathematical modelling such as thresholding, edge detection, region-based segmentation and/or clustering methods.

Thresholding methods utilize a threshold value to transform a greyscale image to a binary one. Known techniques for determining threshold values include histogram thresholding, maximum entropy, maximum variance and k-means clustering.

For edge detection, gradient-based or histogram methods are commonly used. Edges have a rapid change in intensity and these are often linked to form closed object boundaries. Segmentation may also be applied on edge-detected images themselves.

Clustering algorithms comprise unsupervised algorithms which cluster pixels having common attributes into groups allocated to a particular segment. K-means clustering is one variant which considers all the pixels and clusters the pixels into “k” classes.

Alternatively, the first model 102 may utilize probabilistic techniques such as boundary fitting or other specific model-based techniques.

In embodiments, the first model 102 may comprise one or more machine learning models which utilize the one or more medical images 106 as inputs. The input medical images 106 comprise image representations of the anatomical structure and appearance of at least a part of a cervix of a subject.

In embodiments, the first model 102 may comprise one or more neural networks. Any suitable neural network may be used, for example, deep neural networks (DNNs) or other techniques.

In embodiments, the neural networks may comprise convolutional neural networks (CNN). A CNN comprises an input layer, an output layer a sequence of encoding layers therebetween. The encoding layers of a typical CNN may comprise repeated applications of convolution layers, non-linear activation functions and pooling layers for down sampling, followed by one or more dense (fully connected) layers.

In embodiments, the first model 102 may comprise one or more U-Net deep learning algorithms. A U-net is a specific form of CNN comprising an encoding part and a decoding part. The encoding part comprises a contracting path and the decoding part comprises an expansive path.

In embodiments, the contracting path may comprise the repeated application of two 3×3 convolutions, each followed by a rectified linear unit (ReLU) and a 2×2 max pooling operation with stride 2 for down-sampling. At each down-sampling step the number of feature channels is doubled.

Every step in the expansive path consists of an up-sampling of the feature map followed by a 2×2 convolution (“up-convolution”) that halves the number of feature channels, a concatenation with the correspondingly cropped feature map from the contracting path, and two 3×3 convolutions, each followed by a ReLU.

In embodiments, the first model 102 is operable to utilize the input medical images 106 and to classify and segment the curvilinear structures of the cervical canal (CC), inner boundary (IB) and outer boundary (OB), and the volumetric structure of the bladder (BL) from the background to generate the segmentation predictions 110 as the output from the first model 102.

In addition, robust binary masks covering the area near the CC may be generated by applying morphological dilation to the CC predictions.

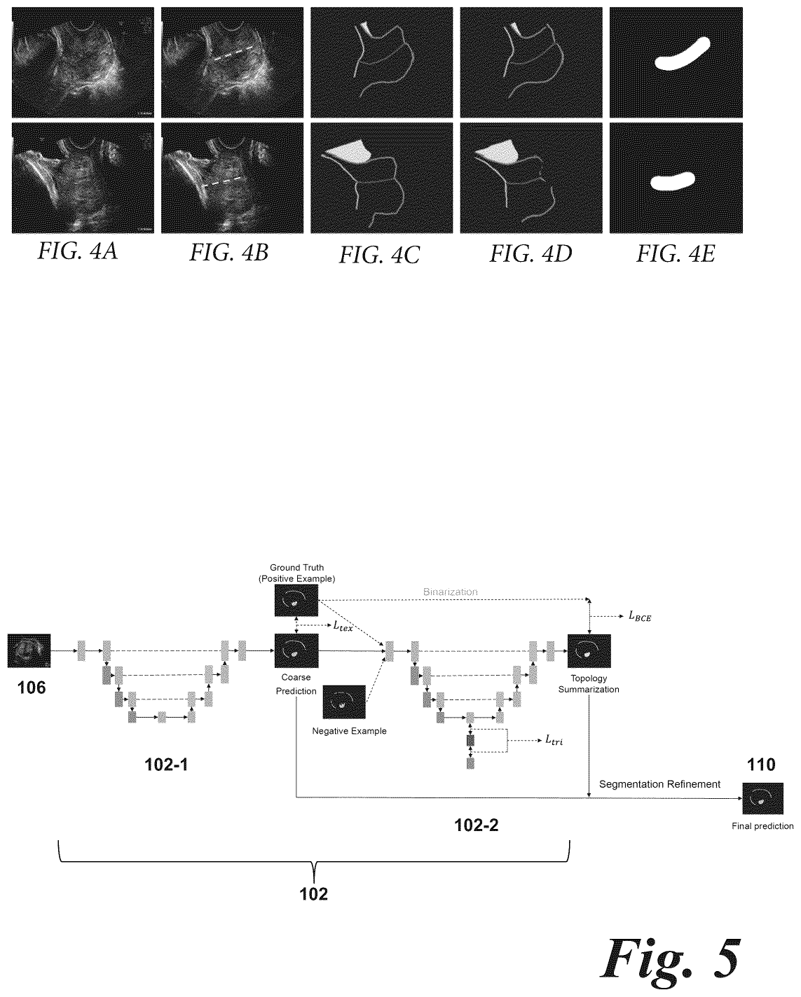

Examples of the input and output from the first model 102 are shown in FIG. 4. FIG. 4 shows an example of data from a term birth (top row) and a preterm birth (bottom row). FIG. 4a shows the original image data 106 in each case. FIG. 4b shows the CL measurements (expert annotated are shown as a solid dark grey line and the predicted measurements as a dashed white line). FIG. 4C shows expert segmentations and FIG. 4D shows predicted segmentations (corresponding to the segmentation predictions 110 of embodiments. Finally, FIG. 4E shows a binary mask created as described above.

Once the segmentation predictions 110 are generated, the one or more measurements 108 of the input anatomical structure can be determined and quantified from the segmentation predictions 110. In embodiments, the one or more measurements comprise cervical length (CL) and/or utero-cervical angle (UCA). From the CC segmentation, in embodiments, the value of the CL is measured from the left and right-most points.

It noted that in embodiments, the first model 102 may be optional and the generated segmentations 110 may be generated from other means, for example by manual methods such as expert annotation or a combination of expert annotation and any suitable model technique outlined above. In addition, the segmentations 110 may be provided from other sources with the ultrasound image(s) or separately.

The second model 104 is operable to receive a plurality of input data types. First, the second model 104 receives the segmentation predictions 110 as a first input. Secondly, the second model 104 receives the input medical images 106 following a pre-processing operation to form pre-processed images 112.

In embodiments, the pre-processing involves removal of potentially confounding image elements such as text and caliper placement. Calipers and other markings may introduce extraneous information that can influence model output. To mitigate the issue of information leakage, which can affect model output, the images are subjected to inpainting to remove the aforementioned information. This is done in a two-step process.

First, the medical image 106 is thresholded in the Hue, Saturation, Value (HSV) color-space. Secondly, the largest connected component is identified, and holes within the component are filled using a hole filling algorithm. These procedures facilitate the removal of extraneous text and features outside of the ultrasound field of view. However, the calipers are still present within this view.

To address this issue, in embodiments, a second thresholding step is performed in the HSV color-space. In embodiments, the resulting mask is then subjected to dilation. The dilated mask can then subsequently be used to identify the pixels for inpainting. Inpainting can then be performed. Once the pre-processed images 112 are generated, they can be used as a second input to the second model 104.

Finally, spatial information 114 representative of the pixel spacing (i.e. spatial resolution) of the respective medical images 106 is provided as a third input to the second model 104.

Spatial information enables determination of the relative scale of the respective medical image 106. This spatial information is, in embodiments, saved in the DICOM files exported from the ultrasound imaging apparatus 50 and/or PACS 30 and can be extracted for use in the model 100.

Spatial information may include other parameters in addition to, or alternative to, the pixel spacing data. For example, the spatial information may include pixel statistics in all or part of the image data. If only a part, the spatial information may include pixel statistics from one or more segmented regions or one or more regions derived from segmented regions. The regions may be derived from morphological dilation or erosion, for example.

In addition, the pixel statistics may comprise one or more of: variance and/or entropy. These values may be determined from the image data directly or after image filtering or morphological operations. Pixel statistics may also be determined from a neural network output (if so used).

From the first, second and third inputs, the second model 104 is operable to generate a prediction 116 of sPTB, i.e. the likelihood of sPTB occurring for the imaged subject under analysis. The second model 104 may take any suitable form.

For example, in embodiments, any suitable form of classifier may be utilized. In embodiments, a model 104 utilizing statistical classification techniques could be utilized where data is clustered based on separation in feature space, such as using clustering and/or K-means techniques. Alternatively, a rules-based classifier may be implemented which comprises a set of rules derived from expert knowledge and/or strategy rules which guide the analysis process.

Alternatively, in embodiments, the model 104 may comprise a support vector machine (SVM) classifier which may, in embodiments, utilize regression, classification and perturbation-based methods.

In embodiments, the model 104 may comprise machine learning and, specifically, utilize one or more neural network algorithms. In embodiments, a neural network such as any suitable form of CNN may be used which is operable to process the relevant input data and generate a suitable prediction of sPTB.

Whilst any suitable model structures and algorithms may be used that can achieve the above functionality, a specific embodiment of the model 100 is described below where the components of the first and second models 102, 104 are described with reference to FIG. 3.

FIG. 3 shows a detailed specific embodiment of the model 100.

### First Model 102

In this embodiment, the first model 102 comprises a dual decoder neural network for curvilinear structure segmentation. This comprises a dual-decoder and topology-aware U-Net of the type as described with reference to Lin, et al “DTU-Net: Learning Topological Similarity for Curvilinear Structure Segmentation” and LNCS, vol. 13939, pp. 654-666. Springer, Cham (2023) which is incorporated herein by reference.

The first model 102 is shown schematically in FIG. 4. The first model 102 structure comprises dual U-net structures, a first U-net 102-1 for texture and a second U-net 102-2 for topology. The texture U-net is operable to encode texture information and provide pixel-wise predictions. The coarse prediction from the texture U-net is then inputted into the topology U-net for topology preservation. The texture U-net comprises an encoder part operable to learn topological features using a self-supervised triplet loss method, and a decoder part configured to summarize the topology in a binary segmentation map indicating image foreground and background.

Note that in FIG. 4 the operations shown in dotted lines are only performed at the training stage (described in the “MODEL TRAINING” section below).

The mini U-net texture network 102-1, the encoder of the topology network 102-2 and the decoder of the topology network 102-2 may be denoted as Θ(⋅)ψ(⋅) and Ω(⋅) respectively. The texture-based and topology-based predictions may then be softly fused to obtain the final segmentation. This is, in embodiments, to avoid overconfidence of the topology network 102-2.

However, the above-recited structure is non-limiting and other structures may be used. For example, the texture net may be replaced by a pre-trained or randomly initialized segmentation network in alternative embodiments. In addition, variants other than a dual U-net may be used as would be readily understood by one skilled in the art.

The first model 102 receives one or more medical images 106 as an input. In embodiments, each medical image 106 may comprise a grayscale B-mode ultrasound image x having a height H and width W (both in pixels), with pixel spacing information p=(pₓ, p_{y}) representing the physical distance between the respective centers of each 2D pixel. In other words, the pixel spacing information comprises the spatial information relating the pixel spacing to the dimensions of the physical dimensions of the imaged object. We can then define a medical image x as x∈ [symbol] ^{H×W×1}.

The first model 102 comprises a segmentation network g of the dual U-net form described above. During inference, g is configured to predict a segmentation map g(x)=m∈ [symbol] ^{H×W×L}, where L is the number of segmentation labels and m_{x,y} represents the probability distribution for the pixel at position (x, y) across the set of learned segmentation labels.

In embodiments, only the K segmentation predictions that are relevant to the classification task are utilized, i.e., m′∈ [symbol] ^{H×W×K}. In embodiments, K may take any suitable integer value. In specific examples, K=5.

### Second Model 104

The second model 104 comprises a CNN including a feature extractor 104-1, an adaption layer 104-2 and a final classification layer 104-3. The second model 104 may take the general form of the “SonoNet” networks described in Baumgartner, C. F., et al. “SonoNet: real-time detection and localisation of fetal standard scan planes in freehand ultrasound”, IEEE TMI 36(11) (2017).

The inventors of the present application have recognised that the shape, size, and texture of the cervix can be utilized in a model to provide results predictive of sPTB. In addition, the inventors have recognised, for the first time, that the inherent texture bias of CNNs present potential barriers to accurate prediction of sPTB.

Therefore, in embodiments, shape and spatial information is injected into the second model 104. The form of the CNN of the second model 104 described above is configured, in embodiments, to process standard plane classification. Given that classification of standard plane quality benefits from combining images with predicted segmentations, the cervical shape information is also included as input.

In addition, because sonographers may adjust image resolution during examinations, and that cervix size and texture has a functional dependence on resolution, pixel spacing data is further included as an additional input.

As a result, the second model 104 is operable to receive a plurality of input data types. First, the second model 104 receives the segmentation predictions 110 m′∈ [symbol] ^{H×W×K} as described above.

Secondly, the second model 104 receives the input medical image 106 x as x∈ [symbol] ^{H×W×1} following a pre-processing operation to form pre-processed images 112.

In embodiments, the pre-processing involves removal of potentially confounding image elements such as text and caliper placement. Calipers and other markings may introduce extraneous information that can influence model output. To mitigate the issue of information leakage, which can affect model output, the images are subjected to inpainting to remove the aforementioned information. This is done in a two-step process as described above in relation to the first embodiment. The pre-processed images 112 in the form of x∈ [symbol] ^{H×W×1} are used as a second input to the second model 104.

Finally, the pixel spatial information 114 representative of the pixel spacing p=(pₓ, p_{y}) (i.e. spatial resolution) of the respective medical images 106 is provided as a third input to the second model 104. In embodiments, the pixel-spacing values (pₓ, p_{y}) are repeated and reshaped to the image dimension H×W, resulting in input channels with the same value at each position for each direction.

The second model 104 is configured to utilize the three input data sources and learn therefrom a mapping f, where f(x, m′, p)|→y, where y indicates a predicted target and f is the second model 104.

The pixel data p (pₓ, p_{y}) is concatenated together with the segmentation predictions m′ and the corresponding (pre-processed) image x. The CNN architecture of the second model 104 thus comprises a shape- and spatially-aware CNN comprising the feature extractor 104-1, the adaption layer 104-2 and the classification layer 104-3.

### Model Training

In embodiments, the first model 102 was trained on an external multi-class segmentation dataset with L=14 structures. This includes 908 cervix images for training and 155 cervix images for test. In addition, standard plane fetal ultrasound images were also used for training and test which comprise standard plane head, abdomen and femur images (1481/271 head, 892/240 abdomen, 639/129 femur).

Each of the mini U-net texture network 102-1 Θ(⋅), the encoder ψ(⋅) of the topology network 102-2 and the decoder Ω(⋅) of the topology network 102-2 can be trained separately. However, the network 102 is trained in a joint way where the gradient backpropagation from the topology network 102-2 can also update the parameters in the texture net. Denoting input images and segmentation ground truth masks as G, the first model 102 is trained by a unified loss:

$${L}_{DTG} ( I , G ) = {L}_{tex} ( Θ ( I ) , G ) + {L}_{BCE} ( Ω ( Ψ ( Θ ( I ) ) ) , \overline{G} ) + {L}_{tri}$$

where Lₜₑₓ is the pixel-wise segmentation loss for the texture network 102-2, L_{BCE} is the binary cross entropy loss tuning the prediction from the topology net, Lₜᵣᵢ is the triplet loss and G and \hat{ }G refers to the ground truth binarized and corrupted. The loss function indicates that the first model 102 does not need additional annotations and learns image topology in a self-supervised way.

The second model 104 was trained using a mini-batch gradient descent method. In embodiments, a Nesterov momentum of 0.9, a categorical cross-entropy loss and an initial learning rate of 0.1 was used. In embodiments, the learning rate was divided by 10 each time the validation error stopped decreasing. In embodiments, a “warm up” learning rate of 0.01 for the first 500 iterations was used.

The dataset used for training was augmented using techniques such as random flipping, rotations, contrast, and brightness. In embodiments, overfitting was reduced and the network made more robust by using scale augmentation. In embodiments, square patches of the input images were extracted by randomly sampling the size of the patch (between 174×174 and 224×224) and then scaling it up to 224×224 pixels.

### EXPERIMENTAL EXAMPLES AND ANALYSIS

To validate the efficiency and performance advantages of the present invention, a comparative analysis with known approaches was performed.

### Dataset for Analysis

The dataset comprised 7862 trans-vaginal ultrasound images extracted from a national fetal ultrasound screening database. The data was anonymized. The original images had different resolutions with the same physical pixel distance in each direction which varied in the range [0.037, 0.276] with a mean of 0.116 mm and standard deviation of 0.027 mm.

The samples coved a range of gestational age (GA) at the time the image scan data was obtained ranging from week 19 to week 32, with equal representation of preterm/term births per GA week. To ensure robust evaluation, a stratified cross-validation strategy was utilized, where folds have non-overlapping patients and evenly sampled term/preterm births per GA week. Furthermore, using the same strategy, each fold was divided into equal-size validation and test sets and swapped during assessment, resulting in 10 splits with 6290/786/786 samples for training/validation/test sets.

Validation of CL Estimates from First Model

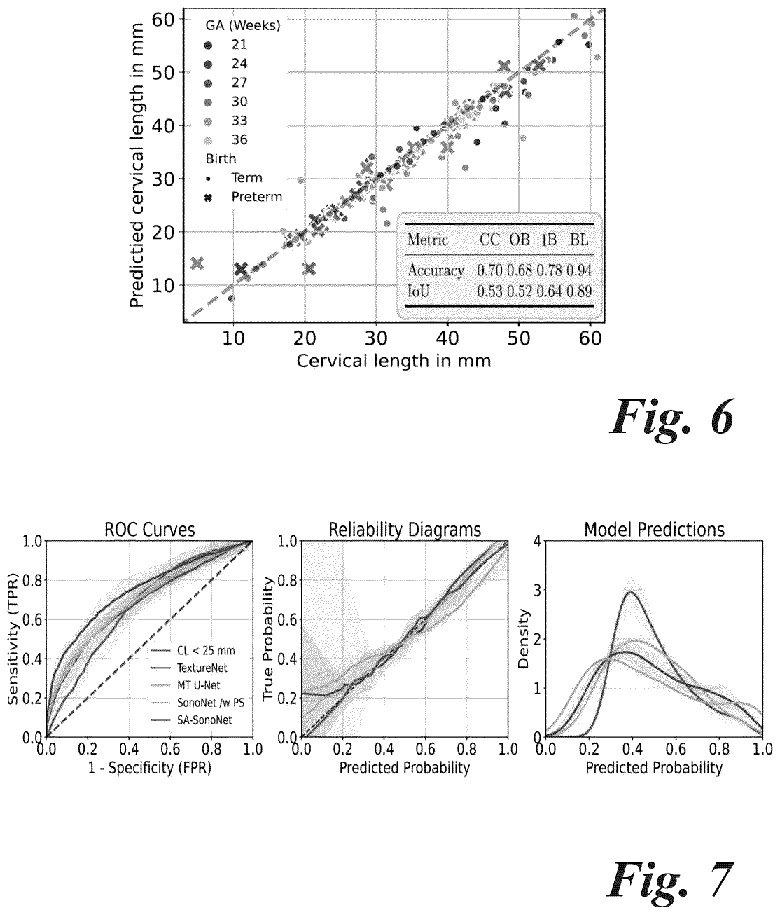

As shown in FIG. 6, the model 100 is operable to accurately identify the CL. FIG. 6 shows the segmentation performance of an embodiment of the model 100 in detecting the four cervical structures, CC, OB, IB, and BL (K=5, including background). Evaluation against expert CL measurements on 155 test images shows a mean absolute error of 1.79 mm, and CL predictions are robust across scan time gestational ages (GAs). Example expert annotations and CL estimations are shown in FIG. 4 and described above. Note that whilst accuracy and IoU are naturally low for thin curvilinear structures, the CL mean absolute error of 1.79 mm indicates that the CC segmentations are indeed appropriate for robustly estimating CL.

### Baselines

An embodiment of the model 100 of the present invention was benchmarked against four baseline methods, including the current clinical standard which defines sPTB when CL<25 mm.

For the comparative analysis, the model 100 of the present invention was used to measure CL automatically. Additionally, a texture-based method was implemented where 102 hand-crafted textural features were extracted from a binary mask covering an area near the cervical canal and apply principal component analysis (PCA) maintaining 97% of the information, i.e., 32 PCA features, which were used to train a two-layer multi-layer perceptron (MLP) called TextureNet.

Furthermore, the results from the model 100 were compared with a multi-task U-Net (MT U-Net), trained both for classification and segmentation of the same binary mask. Finally, a pre-trained SonoNet-32 (such as described in Baumgartner, C. F., et al. “SonoNet: real-time detection and localisation of fetal standard scan planes in freehand ultrasound”, IEEE TMI 36(11) (2017)) was injected with pixel spacing information (SonoNet/w PS) only.

### Implementation Details

All comparative models were trained using binary cross-entropy loss, except the MT U-Net, which followed a multitask loss. An SGD optimizer was used with a momentum of 0.9 and batch size of 64, while the initial learning rate of 10-3 was decayed by a factor of 75% when the validation loss plateaued for 10 epochs.

An L2-regularization of 10⁻⁴ was performed and saved models with the best validation loss for evaluation. TextureNet was implemented with a two-layer MLP with 128 and 64 neurons including batch normalization and drop-out layers. Pyfeats were utilized to extract early and late texture features.

The embodiment of the model 100 for the test was based on pre-trained SonoNet-32 (see, for example, Baumgartner, C. F., et al. “SonoNet: real-time detection and localisation of fetal standard scan planes in freehand ultrasound”, IEEE TMI 36(11) (2017)) with modifications to the first layer to match the input channel size. The images were resized to 224×288, pixel intensity was normalized to [−1, 1], pixel spacing was calculated for the resized images, and injected in mm.

### Results

All methods were evaluated across 10 test splits in terms of area under the curve (AUC), accuracy (ACC), sensitivity (SEN), specificity (SPE), and an unbiased calibration error (UCE). Table 1 below sets out the results.

TABLE 1

| Method | AUC ↑ | ACC ↑ | SEN ↑ | SPE ↑ | UCE ↓ |
|---|---|---|---|---|---|
| CL < 25 mm | 0.673 ± 0.032 | 0.626 ± 0.026 | 0.406 ± 0.043 | 0.846 ± 0.018 | — |
| TextureNet | 0.685 ± 0.025 | 0.642 ± 0.025 | 0.545 ± 0.037 | 0.740 ± 0.027 | 0.015 ± 0.016 |
| MT U-Net | 0.700 ± 0.020 | 0.645 ± 0.019 | 0.558 ± 0.043 | 0.732 ± 0.023 | 0.079 ± 0.024 |
| SonoNet w/PS | 0.700 ± 0.032 | 0.645 ± 0.030 | 0.590 ± 0.048 | 0.700 ± 0.021 | 0.021 ± 0.024 |
| Model 100 | 0.750 ± 0.034 | 0.686 ± 0.033 | 0.629 ± 0.037 | 0.743 ± 0.041 | 0.035 ± 0.021 |

In addition, receiver operating characteristic (ROC) curves (left hand figure), loess-based reliability diagrams (centre) and distribution of model predictions (right hand figure) are shown in FIG. 7. As shown, embodiments of the model 100 demonstrate competitive performance across metrics while being well-calibrated. This allows the model 100 to be used to provide a robust prediction of sPTB.

### Feature Relevance

We assess feature relevance of different inputs of an embodiment of the model 100 by evaluating model performance when removing or modifying parts of the input channels at test time. The results can be found in Table 2 below. Table 2 shows the performance of the model 100 when removing or modifying parts of the inputs; image (IM), cervical canal (CC), outer boundary (OB), inner boundary (IB), bladder (BL), background (BG) defined as the image with all segmented structures subtracted, and pixel spacing (PS). R corresponds to replacing the original PS by random sampling from pixel spacing distributions, and B corresponds to blacking out from the image the pixels surrounding the cervix.

TABLE 2

| IM | CC | OB | IB | BL | BG | PS | AUC | ACC | SEN | SPE |
|---|---|---|---|---|---|---|---|---|---|---|
| ✓ | ✓ | ✓ | ✓ | ✓ | ✓ | ✓ | 0.750 ± 0.034 | 0.686 ± 0.033 | 0.629 ± 0.037 | 0.743 ± 0.041 |
| ✓ | | | | | | ✓ | 0.514 ± 0.038 | 0.505 ± 0.023 | 0.771 ± 0.199 | 0.232 ± 0.212 |
| ✓ | ✓ | | | | | ✓ | 0.514 ± 0.038 | 0.507 ± 0.031 | 0.788 ± 0.190 | 0.220 ± 0.209 |
| ✓ | | ✓ | | | | ✓ | 0.549 ± 0.033 | 0.527 ± 0.023 | 0.744 ± 0.216 | 0.304 ± 0.249 |
| ✓ | | | ✓ | | | ✓ | 0.582 ± 0.048 | 0.539 ± 0.031 | 0.696 ± 0.198 | 0.376 ± 0.239 |
| ✓ | | | | ✓ | | ✓ | 0.512 ± 0.038 | 0.503 ± 0.025 | 0.780 ± 0.192 | 0.220 ± 0.204 |
| ✓ | | | | | ✓ | ✓ | 0.629 ± 0.025 | 0.531 ± 0.028 | 0.917 ± 0.052 | 0.114 ± 0.096 |
| ✓ | ✓ | | | | ✓ | ✓ | 0.663 ± 0.015 | 0.576 ± 0.032 | 0.831 ± 0.057 | 0.320 ± 0.114 |
| ✓ | | ✓ | | | ✓ | ✓ | 0.684 ± 0.021 | 0.615 ± 0.025 | 0.717 ± 0.062 | 0.513 ± 0.108 |
| ✓ | | | ✓ | | ✓ | ✓ | 0.705 ± 0.041 | 0.611 ± 0.044 | 0.820 ± 0.036 | 0.401 ± 0.106 |
| ✓ | | | | ✓ | ✓ | ✓ | 0.633 ± 0.027 | 0.537 ± 0.030 | 0.911 ± 0.051 | 0.163 ± 0.100 |
| ✓ | ✓ | ✓ | ✓ | ✓ | ✓ | | 0.542 ± 0.076 | 0.507 ± 0.037 | 0.831 ± 0.173 | 0.185 ± 0.185 |
| ✓ | ✓ | ✓ | ✓ | ✓ | ✓ | R | 0.681 ± 0.021 | 0.629 ± 0.025 | 0.498 ± 0.096 | 0.758 ± 0.060 |
| | ✓ | ✓ | ✓ | ✓ | ✓ | ✓ | 0.705 ± 0.028 | 0.642 ± 0.032 | 0.677 ± 0.071 | 0.605 ± 0.104 |
| B | ✓ | ✓ | ✓ | ✓ | ✓ | ✓ | 0.733 ± 0.027 | 0.663 ± 0.027 | 0.649 ± 0.091 | 0.676 ± 0.103 |

### Model Interpretation

As shown above, embodiments of the model 100 are well-calibrated and perform well. As a result, confidence scores can be interpreted as risk of preterm birth. Moreover, the feature importance study brings insight into the driving features of the predictions of the model 100.

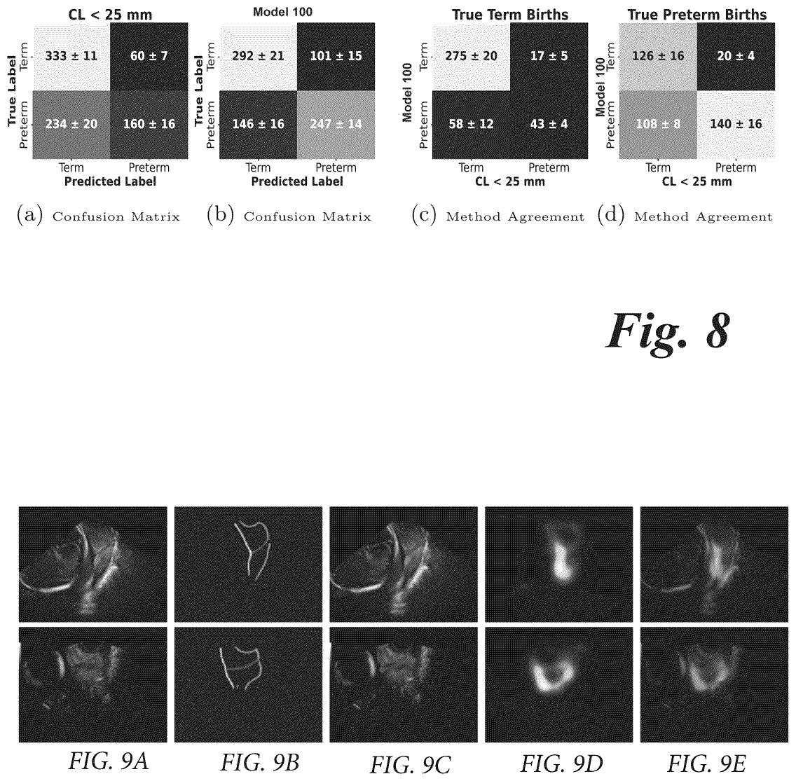

For additional insight into how the model 100 differs from the clinical standard, confusion matrices for CL-based predictions are shown in FIG. 8a and embodiments of the model 100 in FIG. 8b. Moreover, (dis)-agreement matrices between the two approaches for term and preterm births are shown in FIGS. 8c and 8d, respectively. It can be seen that the model performs well against the clinical gold standard and is sufficiently robust to be used as a predictor of the risk of sPTB.

Finally, it is noted that the second model 100 utilizes a fully CNN architecture replacing standard fully-connected layers with 1×1 convolutions. This development maintains the correspondence between class score maps and input images, enabling the extraction of class-specific saliency maps (described below). Examples of high-confidence predictions are shown in FIG. 9.

FIG. 9 shows non-limiting examples of high-confidence preterm birth correct predictions for a short, CL=19.8 mm, (top row) and a larger, CL=30.1 mm, (bottom row) cervix. FIG. 9A shows the respective image 106 without cofounders, FIG. 9B shows the first model's segmentation predictions 100, and FIG. 9C shows the automatic CL measurements 108. In addition, saliency maps on top of the input image are shown in FIG. 9D. These are described below.

### Uncertainty Estimation

As described above, embodiments of the model 100 perform well and are sufficiently well calibrated that confidence scores so generated can be interpreted as risk of preterm birth. Nevertheless, it is advantageous for a clinician and/or sonographer to be presented with a more detailed analysis of the uncertainty underlying the prediction to increase their confidence in the approach of the present invention and enable more informed patient care decisions to be made.

In embodiments, the model 100 is configured to provide an estimate of uncertainty with regard to the generated quantitative values of CL and/or UCA and/or the confidence score as an indication of the risk of sPTB.

In embodiments, test time augmentation is used to estimate measurement uncertainty of the CL and/or UCA values and/or prediction uncertainty of sPTB. Test time augmentation comprises generating a plurality of random modifications to the medical images 106 and running each of the modified images through the model 100. The predictions of each corresponding image can then be used to determine the uncertainty. In other words, test time augmentation comprises the aggregation of predictions across a plurality of transformed versions of an input medical image 106.

In embodiments, the uncertainty was estimated by augmenting the medical images 106 a plurality of times and passing these images 106 through the model 100 to obtain multiple predictions for a) the estimates of CL and/or UCA and b) the risk of sPTB. The standard deviation of the predictions is then used as the initial uncertainty estimate.

The augmentation parameters may comprise generating a number of random modifications to the medical images 106. The random modifications may include, for example, random rotation (±25°), shear (±10°); translation (0.05 of image size); brightness (0.2), contrast (0.2) and random horizontal flip (P=0.5).

The augmentation process may be carried out N times to generate N sets of augmented images. In embodiments, N may be 10.

Further, to evaluate how the error changes as a function of predicted uncertainty, the data can be divided into a plurality of bins with a predetermined width. Therefore, since the errors are normally distributed in the bins, a linear fit can be used to transform the uncertainty prediction into the standard deviation of the error. This enables computation of the confidence intervals for the predictions of the model 100.

### Saliency Maps to Aid Interpretation

Saliency maps enable a visual explanation of model decisions to be presented to the clinician and/or sonographer. In embodiments, saliency maps can be generated and, in embodiments, overlaid on top of the final generated image 116. This enables a straightforward visual verification of the parts of the image 116 which contribute to the prediction of sPTB.

In embodiments, a Gradient-weighted Class Activation Map (Grad-CAM) is utilized. Grad-CAM is based on the gradient of the first and/or second models 102, 104. In Grad-CAM, the gradient is not backpropagated to the original image. Instead, the backpropagation extends to the final convolutional layer. This enables generation of a coarse localization map identifying the key parts of the image 116 which contribute to the prediction of sPTB.

The Grad-CAM method analyses the regions of the image which are activated in the feature maps of the final convolutional layers and weights each pixel of each feature map before averaging takes place to generate a “heatmap”. Negative values are removed by passing the heatmap values through a ReLU function. The value so generated are then scaled appropriately and overlaid on the original image.

By providing such a feature, a straightforward visual verification of the parts of the image 116 which contribute to the prediction of sPTB can be identified by the clinician and/or sonographer.

### Method

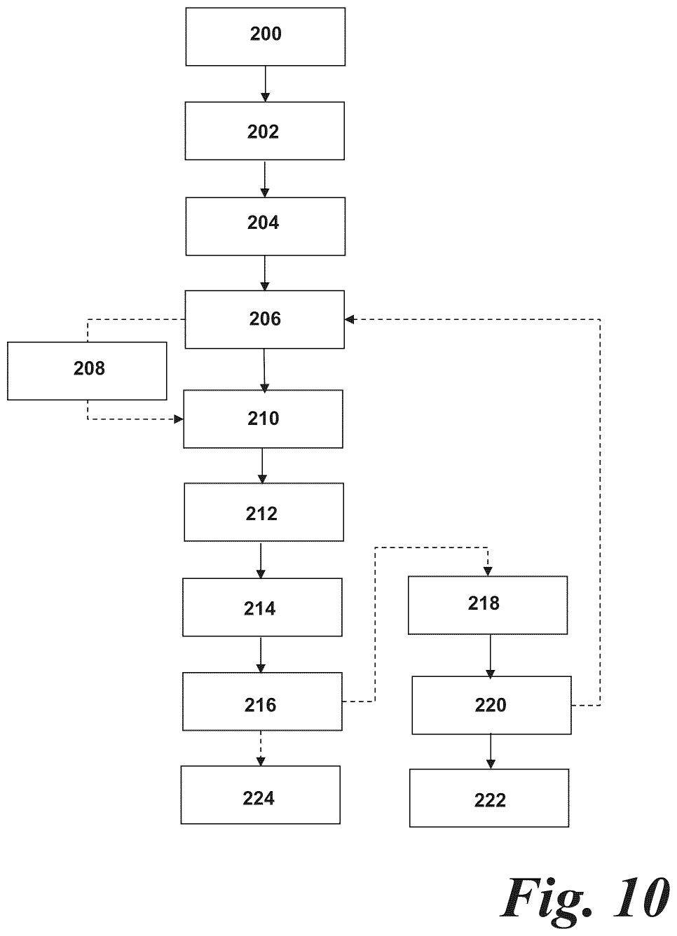

The following method relates to the steps occurring during operation of the sPTB risk assessment method using the medical analysis computing system 10. FIG. 10 shows a flow chart of the method according to an embodiment.

### Step 200: Provide Ultrasound Images

At step 200, one or more ultrasound medical images 106 of a cervix of a subject under assessment are obtained by the medical analysis computing system 10.

In embodiments, the ultrasound medical images 106 may be acquired by the ultrasound imaging apparatus 50 in this step. The ultrasound scanner 52 of the ultrasound imaging apparatus 50 performs trans-vaginal ultrasound to image the cervix of a subject under assessment (i.e. a pregnant woman). The probe 56 transmits the ultrasound signals and recovers reflected ultrasound signals in order to obtain measurement data to enable imaging of the cervix of the subject under assessment.

Sagittal imaging may be obtained by the radiographer making side-to-side movements of the probe 56, and a transverse/semi-coronal orientation may be obtained by the radiographer rotating the probe by 90 degrees. The cervix, endocervical canal and internal os can be imaged in both transverse (short-axis) and sagittal (long-axis) orientations in this step if required.

In embodiments, the measured signals obtained through the scanning operation may comprise B-mode signals which are used to generate B-scan (2D brightness scan) ultrasound images of the cervix from a number of predetermined orientations.

However, this need not be the case and medical images 106 obtained from another ultrasound source may be provided in this step without the step of acquisition of the images 106 by the ultrasound imaging apparatus 50. Whichever route is used, each medical image 106 may comprise a grayscale B-mode ultrasound image x having a height Hand width W (both in pixels)/A medical image x can be defined as x∈ [symbol] ^{H×W×1}.

Optionally, the medical images 106 may be pre-processed and/or transformed for use in the model 100. In embodiments, this may involve one or more of: color transform; cropping; scaling; skewing or resizing of the medical images 106 before provision to the model 100.

If the obtained image data is not already in the required format, in specific embodiments, the medical images 106 may be converted to grayscale and/or center cropped. However, this is not to be taken as limiting and other transformations may be used. In specific embodiments, the medical images 106 may be resized to dimensions of 224×224 pixels. However, this is not to be taken as limiting and other scaling(s) may be used.

### Step 202: Obtain Spatial Information

Spatial information for the medical images 106 is obtained in step 202. This step may be performed concurrently and as part of step 200, or it may be separate. In a specific embodiment the spatial information may be extracted from the DICOM file(s) of the image(s) 106. In a non-limiting embodiment, they may be extracted from a scale bar in the image or other sources.

In embodiments, the spatial information comprises pixel spacing information p=(pₓ, p_{y}) representing the physical distance between the respective centers of each 2D pixel. In other words, the pixel spacing information comprises the spatial information relating the pixel spacing to the dimensions of the physical dimensions of the imaged object.

Spatial information may include other parameters in addition to (or potentially as an alternative to) the pixel spacing data. For example, the spatial information may include pixel statistics in all or part of the image data. If only a part, the spatial information may include pixel statistics from one or more segmented regions, or one or more regions derived from segmented regions. The regions may be derived from morphological dilation or erosion, for example.

In addition, the pixel statistics may comprise one or more of: variance and/or entropy. These values may be determined from the image data directly or after image filtering or morphological operations. Pixel statistics may also be determined from a neural network output (if so used).

The method proceeds to step 204.

### Step 204: Input Images to First Model

At step 204, the one or more medical images 106 obtained or generated in step 200 as are input into the first model 102.

In embodiments, each medical image 106 may comprise a grayscale B-mode ultrasound image x having a height Hand width W (both in pixels), with pixel spacing information p=(pₓ, p_{y}) representing the physical distance between the respective centers of each 2D pixel as obtained in step 202. The input medical image 106 (x) is defined as x∈ [symbol] ^{H×W×1}.

### Step 206: Generate Segmentation Predictions

At step 206, the first model 102 generates segmentation predictions.

At step 206, the first model 102 utilizes the input medical images 106 and to classify and segment the curvilinear structures of the cervical canal (CC), inner boundary (IB) and outer boundary (OB), and the volumetric structure of the bladder (BL) from the background to generate the segmentation predictions 110 as the output from the first model 102.

In specific embodiments, the first model 102 structure comprises dual U-net structures, a first U-net 102-1 for texture and a second U-net 102-2 for topology. The texture U-net is operable to encode texture information and provide pixel-wise predictions. The coarse prediction from the texture U-net is then inputted into the topology U-net for topology preservation. The texture U-net comprises an encoder part operable to learn topological features using a self-supervised triplet loss method, and a decoder part configured to summarize the topology in a binary segmentation map indicating image foreground and background.

In specific embodiments, the mini U-net texture network 102-1, the encoder of the topology network 102-2 and the decoder of the topology network 102-2 may be denoted as Θ(⋅)ψ(⋅) and Ω(⋅) respectively. The texture-based and topology-based predictions may then be softly fused to obtain the final segmentation. This is, in embodiments, to avoid overconfidence of the topology network 102-2.

However, the above-recited structure is non-limiting and other structures may be used. For example, the texture net may be replaced by a pre-trained or randomly initialized segmentation network in alternative embodiments. In addition, variants other than a dual U-net may be used as would be readily understood by one skilled in the art and as described in the “MODEL ARCHITECTURE” section.

In specific embodiments, the first model 102 comprises a segmentation network g of the dual U-net form described above. During step 206, g is configured to predict a segmentation map g(x)=m∈ [symbol] ^{H×W×L}, where L is the number of segmentation labels and m_{x,y} represents the probability distribution for the pixel at position (x, y) across the set of learned segmentation labels.

In embodiments, only the K segmentation predictions that are relevant to the classification task are utilized, i.e., m′∈ [symbol] ^{H×W×K}. In embodiments, K may take any suitable integer value. In specific examples, K=5.

Once the segmentation predictions are generated, the method proceeds to step 208.

It is noted that steps 206 and 208 may be optional and the first model 102 need not be provided. For example, the segmentations 110 may be provided from another source for use with the method of the invention, or may be generated by means other than the specific embodiments of the first model 102 as described.

### Step 208: Generate Binary Masks

Step 208 is optional. At step 208, robust binary masks covering the area near the CC may be generated by applying morphological dilation to the CC predictions.

### Step 210: Generate Qualitative Measurements of Cervical Parameters

Once the segmentation predictions 110 are generated at step 206, one or more measurements 108 of the input anatomical structure can be determined and quantified from the segmentation predictions 110.

In embodiments, the one or more measurements comprise cervical length (CL) and/or utero-cervical angle (UCA). From the CC segmentation, in embodiments, the value of the CL is measured from the left and right-most points.

### Step 212: Process Medical Image(s) 106

At step 212, the medical image(s) are pre-processed. The pre-processing involves removal of potentially confounding image elements such as text and caliper placement. Calipers and other markings may introduce extraneous information that can influence model output. To mitigate the issue of information leakage, which can affect model output, the images are subjected to inpainting to remove the aforementioned information. This is done in a two-stage process in step 212.

First, the medical image 106 is thresholded in the Hue, Saturation, Value (HSV) color-space. Secondly, the largest connected component is identified, and holes within the component are filled using a hole filling algorithm. These procedures facilitate the removal of extraneous text and features outside of the ultrasound field of view. However, the calipers are still present within this view.

To address this issue, in embodiments, a second thresholding stage is performed in the HSV color-space. In embodiments, the resulting mask is then subjected to dilation. The dilated mask can then subsequently be used to identify the pixels for inpainting. Inpainting can then be performed. Once the pre-processed images 112 are generated, they can be used as a further input to the second model 104 in step 214.

In addition, step 212 could also be optionally performed prior to step 202 and the processed images utilized in the segmentation process.

### Step 214: Input Data to Second Model 104

In step 214, the segmentation predictions generated in step 206, the pre-processed image data obtained in step 212, and the pixel data obtained in step 202 are input into the second model 104.

The inventors of the present application have recognised that the shape, size, and texture of the cervix can be utilized in a model to provide results predictive of sPTB. In addition, the inventors have recognised, for the first time, that the inherent texture bias of CNNs present potential barriers to accurate prediction of sPTB. Therefore, in embodiments, shape and spatial information is injected into the second model 104.

In detail, because sonographers may adjust image resolution during examinations, and that cervix size and texture has a functional dependence on resolution, pixel spacing data is further included as an additional input.

As a result, the second model 104 is operable to receive a plurality of input data types in step 214.

First, the second model 104 receives the segmentation predictions 110 m′∈ [symbol] ^{H×W×K}.

Secondly, the second model 104 receives the input medical image 106 x as x∈ [symbol] ^{H×W×1} following a pre-processing operation to form pre-processed images 112. The pre-processed images 112 in the form of x∈ [symbol] ^{H×W×1} are used as a second input to the second model 104.

Finally, the pixel spatial information 114 representative of the pixel spacing p=(pₓ, p_{y}) (i.e. spatial resolution) of the respective medical images 106 is provided as a third input to the second model 104. In embodiments, the pixel-spacing values (pₓ, p_{y}) are repeated and reshaped to the image dimension H×W, resulting in input channels with the same value at each position for each direction.

The method proceeds to step 216.

Step 216: Generate Prediction of sPTB

From the first, second and third inputs in step 214, the second model 104 is operable to generate a prediction 116 of sPTB, i.e. the likelihood of sPTB occurring for the imaged subject under analysis.

The second model 104 may take any suitable form as described above under the “MODEL ARCHITECTURE” section. If the model 104 utilizes a neural network architecture then, for example, any suitable form of CNN may be used which is operable to process the relevant input data and generate a suitable prediction of sPTB.

In specific embodiments, the second model 104 comprises a CNN including a feature extractor 104-1, an adaption layer 104-2 and a final classification layer 104-3.

In embodiments, the second model 104 is configured to utilize the three input data sources from step 214 and learn therefrom a mapping f, where f(x, m′, p)|→y, where y indicates a predicted target and f is the second model 104. The pixel data p (pₓ, p_{y}) is concatenated together with the segmentation predictions m′ and the corresponding (pre-processed) image x.

This enables the method of the present invention to predict a belief in whether the subject of the images 106 will give birth preterm or not. Given the well-calibrated model, this belief can be interpreted as a probability of preterm birth.

Optionally, uncertainty may be determined for the generated values and beliefs according to the following steps.

As described above, embodiments of the model 100 perform well and are sufficiently well calibrated that confidence scores so generated can be interpreted as risk of preterm birth. Nevertheless, it is advantageous for a clinician and/or sonographer to be presented with a more detailed analysis of the uncertainty underlying the prediction to increase their confidence in the approach of the present invention and enable more informed patient care decisions to be made.

In steps 218 to 222, the model 100 is configured to provide an estimate of uncertainty with regard to the generated quantitative values of CL and/or UCA and/or the confidence score as an indication of the risk of sPTB.

### Step 218: Generate Augmented Medical Images

At step 218, random modifications to the medical images 106 are generated to generate an augmented set of images. The random modifications may include, for example, random rotation (±25°), shear (±10°); translation (0.05 of image size); brightness (0.2), contrast (0.2) and random horizontal flip (P=0.5).

The augmentation process may be carried out N times to generate N sets of augmented images. In embodiments, N may be 10.

Once one or more augmented images have been generated, the method proceeds to step 220 for one set of the N sets of augmented images.

Step 220: Generate CL and/or UCA Values and/or Probability of sPTB from Augmented Images

At step 220, steps 204 to 216 are run based on a set of augmented images. This step is repeated for further augmented images until N predictions have been carried out.

### Step 222: Derive Uncertainty Estimate

At step 222, the standard deviation of the predictions is then used as the initial uncertainty estimate. However, in this form the uncertainty metric is not meaningful.

Therefore, in embodiments, to evaluate how the error changes as a function of predicted uncertainty, a linear fit can be used to transform the uncertainty prediction into the standard deviation of the error. This allows computation of the confidence intervals for the model predictions.

In addition, saliency maps may be implemented if required in step 224. Step 224 is optional and may follow step 216.

### Step 224: Generate Saliency Maps

Saliency maps enable a visual explanation of model decisions to be presented to the clinician and/or sonographer. In embodiments, saliency maps can be generated and, in embodiments, overlaid on top of the final generated image 116. This enables a straightforward visual verification of the parts of the image 116 which contribute to the prediction of sPTB.

In step 224, saliency maps may be generated based on any suitable method. For example, a modified guided backpropagation technique may be used.

In embodiments, a Gradient-weighted Class Activation Map (Grad-CAM) may be utilized. Grad-CAM is based on the gradient of the first and/or second models 102, 104. In Grad-CAM, the gradient is not backpropagated to the original image. Instead, the backpropagation extends to the final convolutional layer. This enables generation of a coarse localization map identifying the key parts of the image 116 which contribute to the prediction of sPTB.

The Grad-CAM method analyses the regions of the image which are activated in the feature maps of the final convolutional layers and weights each pixel of each feature map before averaging takes place to generate a “heatmap”. Negative values are removed by passing the heatmap values through a ReLU function. The value so generated are then scaled appropriately and overlaid on the original image.

At step 224, a straightforward visual verification of the parts of the image 116 which contribute to the prediction of sPTB can be identified by the user (e.g. medical practitioner, clinician and/or sonographer) can be generated.

### Method of Use Embodiment

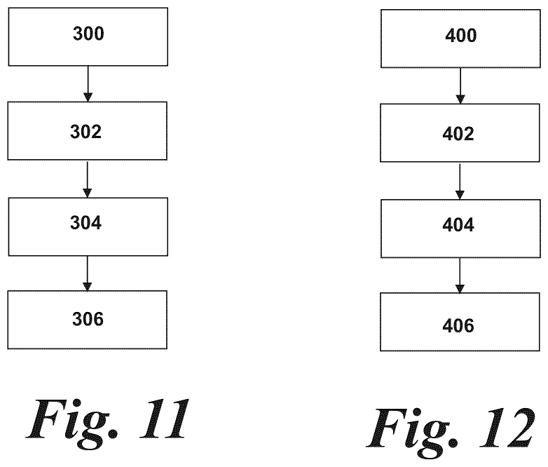

The following method relates to a further embodiment of the invention and comprises steps occurring during operation of a further method using the medical analysis computing system 10. FIG. 11 shows a flow chart of the method according to the further embodiment.

The method of this embodiment may use, but is not limited to, the model 100 of the earlier embodiments. Any suitable ensemble model operable to extract uncertainty values from a plurality of ultrasound images may be used.

### Step 300: Acquire Ultrasound Images

At step 300, ultrasound medical images 106 of a cervix of a subject under assessment are obtained by an operator of the medical analysis computing system 10.

In embodiments, the ultrasound medical images 106 are acquired by the ultrasound imaging apparatus 50 in this step. The ultrasound scanner 52 of the ultrasound imaging apparatus 50 performs trans-vaginal ultrasound to image the cervix of the subject under assessment. The probe 56 transmits the ultrasound signals and recovers reflected ultrasound signals in order to obtain measurement data to enable imaging of the cervix of the subject under assessment.

Sagittal imaging may be obtained by the radiographer making side-to-side movements of the probe 56, and a transverse/semi-coronal orientation may be obtained by the radiographer rotating the probe by 90 degrees. The cervix, endocervical canal and internal os can be imaged in both transverse (short-axis) and sagittal (long-axis) orientations in this step if required.

In embodiments, the measured signals obtained through the scanning operation may comprise B-mode signals which are used to generate B-scan (2D brightness scan) ultrasound images of the cervix from a number of predetermined orientations.

However, this need not be the case and medical images 106 obtained from another ultrasound source may be provided in this step without the step of acquisition of the images 106 by the ultrasound imaging apparatus 50. Whichever route is used, each medical image 106 may comprise a grayscale B-mode ultrasound image x having a height Hand width W (both in pixels)/A medical image x can be defined as x∈ [symbol] ^{H×W×1}.

Optionally, the medical images 106 may be pre-processed and/or transformed for use in the model 100. In embodiments, this may involve one or more of: color transform; cropping; scaling; skewing or resizing of the medical images 106 before provision to the model 100.

If the obtained image data is not already in the required format, in specific embodiments, the medical images 106 may be converted to grayscale and/or center cropped. However, this is not to be taken as limiting and other transformations may be used. In specific embodiments, the medical images 106 may be resized to dimensions of 224×224 pixels. However, this is not to be taken as limiting and other scaling(s) may be used.

### Step 302: Estimate Parameters, Risk Likelihood and Uncertainty

At step 302, a plurality of sets of the ultrasound images acquired in step 302 are used in an ensemble model comprising one or more neural networks to determine CL, UCA and probable likelihood of sPTB and generate an associated uncertainty estimate for the one or more of these parameters.

This may be done in accordance with the embodiments above or may be done in accordance with any other suitable method. Uncertainty estimates may be obtained in accordance with methods above using augmented images or via any other suitable method.

### Step 304: Provide Notification

At step 304, a notification to the operator of the ultrasound imaging apparatus 50 is provided in respect of one or more parameters indicative of the accuracy of one or more of the obtained ultrasound images.

The notification may be in the form of one or more parameters of one or more images of a set or as acquired in step 300. In embodiments, the or each parameter may be indicative of a particular quantity or property of one or more medical images 106 or information derived therefrom.

In embodiments, a notification may be provided if one or more of the parameters exceeds a particular threshold for a particular property or quantity in one or more of the medical images 106 or in information derivable therefrom.

For example, a notification may be provided to inform the operator that one or more of the medical images 106 has an associated uncertainty (derived in step 302) which does not meet an acceptable threshold for accuracy.

By way of further example, a notification may be provided to inform the operator that one or more of the three medical images 106 has one or more parameters related to image quality which do not meet an acceptable threshold.

### Step 306: Automatically Obtain Images

Step 306 may be an optional step. If at step 300 a plurality of images is obtained and the notification optionally provided at step 304 to inform the operator which of the plurality of images obtained has the lowest uncertainty and/or has the highest accuracy, step 306 may be carried out

At step 306, a subset of the total set of medical images obtained in step 300 may be selected automatically for determination of the cervix parameters and risk likelihood of sPTB. On this basis, the operator may be notified of the images having the lowest uncertainty and that these images have been selected to determine the above parameters.

### Further Method of Use Embodiment

A further specific embodiment of the method of use of the present invention is described with reference to FIG. 12.

### Step 400: Acquire Multiple Ultrasound Images

At step 400, ultrasound medical images 106 of the cervix of a subject under assessment are obtained by an operator of the medical analysis computing system 10. In embodiments, step 400 proceeds as described above in respect of step 300 to acquire a plurality of medical images.

In embodiments, at step 400, the operator acquires ultrasound images comprising image data representative of the anatomical structure and appearance of the cervix.

In embodiments, step 400 comprises obtaining multiple images of the cervix.

Pre-processing and other image processing operations may be performed on the images, and spatial information may be obtained as described in step 300 above. The method proceeds to step 402.

### Step 402: Determine Uncertainty for Each Captured Image

At step 402, for each captured image in step 400, steps 204 to 222 are repeated to determine the cervical parameters and associated uncertainties.

### Step 404: Provide Notification

At step 404, a notification to the operator of the ultrasound imaging apparatus 50 is provided in respect of one or more parameters indicative of the accuracy of one or more of the obtained ultrasound images.

In this embodiment, the notification may comprise providing the operator with information in relation to the uncertainty and/or the accuracy of one or more of the images 106. The notification may comprise an indication of the image(s) having the lowest uncertainty and/or highest accuracy, or the images may be highlighted to the operator for selection by the operator.

In embodiments, any metric of the accuracy of the images may be derived directly from the uncertainty measurements.

In embodiments, the operator may then select the best images based on the notification. Alternatively or additionally, optional step 406 may perform some steps automatically with the notification comprising information relating to the automatic selection of the image(s) having the lowest uncertainty and/or highest accuracy, or the image(s) highlighted for the operator. This is described in step 406 below.

### Step 406: Automatically Obtain Images

Step 406 may be an optional step or may be part of step 404. At step 406, the image 106 from the total set of medical images obtained in step 400 may be selected automatically for determination of cervical parameters. On this basis, the operator may be notified of the images having the lowest uncertainty and therefore the highest accuracy, and that these images have been selected to determine the necessary parameters.

Alternatively or additionally, the estimated parameters for the obtained images may be averaged and provide the operator with an averaged value for the parameters

It will be appreciated by the person of skill in the art that various modifications may be made to the above-described examples without departing from the scope of the invention as defined by the appended claims.

While the invention has been described with reference to the preferred embodiments depicted in the figures, it will be appreciated that various modifications are possible within the spirit or scope of the invention as defined in the following claims.

In this specification, unless expressly otherwise indicated, the word “or” is used in the sense of an operator that returns a true value when either or both of the stated conditions are met, as opposed to the operator “exclusive or” which requires only that one of the conditions is met. The word “comprising” is used in the sense of “including” rather than to mean “consisting of”.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

While various operations have been described herein in terms of “modules”, “units” or “components,” these terms should not limited to single units or functions. In addition, functionality attributed to some of the modules or components described herein may be combined and attributed to fewer modules or components.

It will be apparent to those of ordinary skill in the art that changes, additions or deletions may be made to the disclosed embodiments without departing from the spirit and scope of the invention. For example, one or more portions of methods described above may be performed in a different order (or concurrently) and still achieve desirable results.

1. A computer-implemented method for prediction of parameters indicative of the risk of spontaneous preterm birth (sPTB) for a subject under assessment, the method being executed by at least one hardware processor and comprising the steps of:
a) providing one or more ultrasound images comprising medical image data representative of the anatomical structure and appearance of at least a part of a cervix of the subject;
b) providing a plurality of segmentations of the medical image data each representative of one or more features of the anatomical structure and appearance of the at least a part of the cervix of the subject; and
c) utilizing i) the medical image data, ii) spatial information associated with the medical image data and iii) one or more of the segmentations in a classifier model to determine a prediction metric indicative of the likelihood of sPTB for the subject.

2. A computer-implemented method according to claim 1, wherein step b) comprises:
d) utilizing the medical image data in a segmentation model configured to perform segmentation of the medical image data to generate the plurality of segmentations each representative of features of the anatomical structure and appearance of the at least a part of the cervix of the subject.

3. A computer-implemented method according to claim 2, wherein the segmentation model comprises a machine learning model.

4. A computer-implemented method according to claim 3, wherein the segmentation model comprises one or more neural networks.

5. A computer-implemented method according to claim 4, wherein the segmentation model comprises one or more U-net convolutional neural networks.

6. A computer-implemented method according to claim 2, further comprising:
e) automatically determining a qualitative value for one or more clinical cervical parameters based on the plurality of segmentations.

7. A computer-implemented method according to claim 6, wherein the one or more clinical cervical parameters comprise cervical length (CL) and/or utero-cervical angle (UCA).

8. A computer-implemented method according to claim 1, wherein the classifier model comprises one or more machine learning classifiers.

9. A computer-implemented method according to claim 8, wherein the classifier model comprises one or more neural network classifiers.

10. A computer-implemented method according to claim 1, wherein the spatial information comprises pixel spacing information representing the physical distance between the respective centers of each pixel.

11. A computer-implemented method according to claim 1, wherein the spatial information comprises pixel statistical information.

12. A computer-implemented method according to claim 11, wherein the pixel statistical information comprises the variance and/or entropy of at least a part of the medical image data.

13. A computer-implemented method according to claim 12, wherein the pixel statistical information relates to a part of the medical image data derived from one or more segmented regions of one or more segmentations.

14. A computer-implemented method according to claim 1, wherein, prior to step c), the medical input data is pre-processed to remove embedded text and/or markings from the one or more ultrasound images.

15. A computer-implemented method according to claim 1, wherein the prediction metric comprises a probabilistic risk score.

16. A computer-implemented method according to claim 1, further comprising:
f) generating an uncertainty estimate for the prediction metric.

17. A computer-implemented method according to claim 16, wherein step f) further comprises:
g) applying one or more transforms to the one or more ultrasound images to generate a set of augmented images;
h) performing steps b) and c) using the set of augmented images to determine a prediction metric based on the set of augmented images.

18. A computer-implemented method according to claim 17, wherein the steps g) and h) are repeated N times to generate N values of the prediction metric.

19. A computer-implemented method according to claim 18, wherein the one or more transforms are randomly selected from one or more of: rotation; shear; translation; brightness; contrast; and horizontal flip.

20. A computer-implemented method according to claim 1, wherein step a) comprises:
i) generating one or more trans-vaginal ultrasound images of the at least a part of the cervix using an ultrasound imaging apparatus.

21. A computational model for prediction of parameters indicative of the risk of spontaneous preterm birth (sPTB) for a subject under assessment, the computational model comprising:
a classification model comprising one or more classifiers configured to process i) medical image data from one or more ultrasound images, the medical image data being representative of the anatomical structure and appearance of at least a part of a cervix of a subject, ii) spatial information associated with the medical image data and iii) a plurality of segmentations of the medical image data each representative of one or more features of the anatomical structure and appearance of the at least a part of the cervix of the subject to determine a prediction metric indicative of the likelihood of sPTB for the subject.

22. A computational model according to claim 21, further comprising a segmentation model configured to perform segmentation of the medical image data to generate the plurality of segmentations each representative of features of the anatomical structure and appearance of the at least a part of the cervix of the subject.

23. A computational model according to claim 22, wherein the segmentation model is further configured to determine a qualitative value for one or more clinical cervical parameters based on the plurality of segmentations.

24. A computational model according to claim 21, wherein the classification model comprises a machine learning model.

25. A computational model according to claim 24, wherein the classification model comprises one or more neural networks.

26. A computer-implemented method according to claim 22, wherein the segmentation model comprises a machine learning model.

27. A computer-implemented method according to claim 26, wherein the segmentation model comprises one or more U-net convolutional neural networks.

28. A computing system for prediction of parameters indicative of the risk of spontaneous preterm birth (sPTB) for a subject under assessment, the computing system comprising:
at least one hardware processor; and
an analyzer, the analyzer comprising:
a classification model comprising one or more classifiers configured to process i) medical image data from one or more ultrasound images, the medical image data being representative of the anatomical structure and appearance of at least a part of a cervix of a subject, ii) spatial information associated with the medical image data and iii) a plurality of segmentations of the medical image data each representative of one or more features of the anatomical structure and appearance of the at least a part of the cervix of the subject to determine a prediction metric indicative of the likelihood of sPTB for the subject.

29. A computing system according to claim 28, wherein the analyzer further comprises a segmentation model configured to perform segmentation of the medical image data to generate the plurality of segmentations each representative of features of the anatomical structure and appearance of the at least a part of the cervix of the subject.

30. An ultrasound imaging apparatus comprising an ultrasound scanner configured to generate a plurality of trans-vaginal ultrasound images of at least a part of the cervix of a subject under assessment and the computing system according to claim 28.

31. A non-transitory computer readable storage medium storing a program of instructions executable by at least one hardware processor to perform the steps of:
a) providing one or more ultrasound images comprising medical image data representative of the anatomical structure and appearance of at least a part of a cervix of the subject;
b) providing a plurality of segmentations of the medical image data each representative of one or more features of the anatomical structure and appearance of the at least a part of the cervix of the subject; and
c) utilizing i) the medical image data, ii) spatial information associated with the medical image data and iii) one or more of the segmentations in a classifier model to determine a prediction metric indicative of the likelihood of sPTB for the subject.

32. A method of performing ultrasound examination of a subject under assessment to predict parameters indicative of the risk of spontaneous preterm birth (sPTB), the method comprising the steps of:
a) acquiring a plurality of trans-vaginal ultrasound images of at least a part of a cervix of the subject using an ultrasound imaging apparatus, the one or more ultrasound images comprising medical image data representative of the anatomical structure and appearance of at least a part of the cervix;
b) utilizing, on a computing system, the ultrasound images in a computational model to determine qualitative values for one or more clinical cervical parameters and/or a prediction metric indicative of the likelihood of sPTB for the subject;
c) utilizing, on the computing system, the computational model to generate an associated uncertainty estimate for the qualitative values for the one or more clinical cervical parameters and/or the prediction metric indicative of the likelihood of sPTB for the subject; and
d) providing, based on the uncertainty estimate, a notification to the operator of the ultrasound imaging apparatus in respect of one or more parameters indicative of the accuracy of one or more of the obtained ultrasound images.

33. A method according to claim 32, wherein step b) further comprises determining qualitative values for one or more clinical cervical parameters by:
e) providing a plurality of segmentations of the medical image data each representative of one or more features of the anatomical structure and appearance of the at least a part of the cervix of the subject; and
f) automatically determining a qualitative value for one or more clinical cervical parameters based on the plurality of segmentations.

34. A method according to claim 33, wherein step e) further comprises:
g) utilizing the medical image data in a segmentation model of the computational model configured to perform segmentation of the medical image data to generate the plurality of segmentations each representative of features of the anatomical structure and appearance of the at least a part of the cervix of the subject.

35. A method according to claim 32, wherein step b) further comprises determining a prediction metric indicative of the likelihood of sPTB for the subject by:
h) utilizing i) the medical image data, ii) spatial information associated with the medical image data and iii) one or more of the segmentations in a classifier model of the computational model to determine a prediction metric indicative of the likelihood of sPTB for the subject.

36. An ultrasound imaging apparatus comprising:
an ultrasound scanner configured to obtain a plurality of trans-vaginal ultrasound images of at least a part of the cervix of a subject under assessment, the one or more ultrasound images comprising medical image data representative of the anatomical structure and appearance of at least a part of the cervix;
a computing system comprising at least one hardware processor and configured to:
utilize the ultrasound images in a computational model to determine qualitative values for one or more clinical cervical parameters and/or a prediction metric indicative of the likelihood of sPTB for the subject;
utilize the computational model to generate an associated uncertainty estimate for the qualitative values for the one or more clinical cervical parameters and/or the prediction metric indicative of the likelihood of sPTB for the subject; and
provide, based on the uncertainty estimate, a notification to the operator of the ultrasound in respect of one or more parameters indicative of the accuracy of one or more of the obtained ultrasound images.
